(19) United States
(12) Patent Application Publication
(10) Pub. No.: US 2004/0111369 A1
(43) Pub. Date: Jun. 10, 2004

(54) Method to associate the geographic location of a participant with the content of a communications session

(76) Inventors: Kathleen Heila Lane, Los Altos Hills, CA (US); William Hustack Lane, Los Altos Hills, CA (US)

Correspondence Address: PATRICK REILLY, BOX 7218, SANTA CRUZ, CA, 95061-7218, US

(21) Appl. No.: 10/300,292

(22) Filed: Nov. 20, 2002

(51) Int. Cl. G06F 17/60

(52) U.S. Cl. 705/40

(57) ABSTRACT

A method to associate the geographic location of a participant in a communications session, such as a phone call or an email transmission, is provided. The method may enable a virtual retail store or virtual point of sale, and may further comprise a virtual repository of information relating to transmitted messages, transactions and/or transaction requests. The participant is provided with a communications device, e.g., a cell phone, a personal digital assistant, or a personal computer, the device being optionally coupled with a GPS receiving circuit. The participant may use a password, an account number, a voice tag and/or an electronic signature as a record to confirm the participant's identity and co-location with the communications device substantially simultaneous with the communications session. The record may be stored for later review in the virtual repository. Alternatively, the location of a wireless communications device may be determined by radio signal direction finding equipment.

### TECHNICAL FIELD

This invention relates to determining the location of a communications device incident to a communications session. The present invention more particularly relates to confirming the identity and instantaneous geographic identity of a selected participant of the communications session.

### BACKGROUND ART

Communications devices, such as phones, wireless phones, pagers, personal digital assistants and personal computers, are used by the general public to transmit messages having a wide range of informational content. Determining the location of the communications device during a communications session is sometimes determinable by means of the global position system (“GPS”) and GPS receiving circuitry located within, or coupled to, the communications devices. Alternatively or additionally, where the communications device participates in the communication session by means of electromagnetic or radio wave transmission, or the communications device is a wireless communications device, the communications device may be geographically located by triangulating the location of the transmitting communications device from at least two electromagnetic energy receiving systems, where the receiving systems each are positioned at known locations during a triangulation sampling process.

The geographic location of a human being during a transmission of information, such as in a lottery ticket purchase, or placing, an order with a licensed broker to sell or buy a publicly traded security or a securities sales option, or the serving of a court order or injunction, is in certain circumstances relevant to, or determinative of, the legality or legal effectiveness of the intent of an act of communications. In particular, the purchase of lottery tickets are on occasion limited to transactions where the purchaser is legally required to be located within a predetermined geography of a legal jurisdiction, e.g. the State of California. As another example, the sale or purchase of a registered security may be subject to a federal regulation, wherein the regulation requires the broker accepting the order to be licensed in the jurisdiction in which the buyer or seller is located at the moment of placing the sell or buy order. Still other practical examples of verifying the geographic location of a human being during a transaction would be legally relevant would include certain acts having tax consequences, and the placing of a wager with legitimate casinos, such as the MGM Grand Casino.

Hand-held GPS devices, such as the Scout by Trimble Navigation, Ltd., wireless personal digital assistants, such as the NOKIA 9290 and the PALM i705, hand-held cellular telephone devices, such as the NOKIA 6110, are well known in the prior art. The methods of determining the location of a communications device having, or coupled with, a GPS receiving circuit, are also well known in the art. In addition, methods of determining the location, or approximate location, of a wireless communications device by means of triangulation, and other suitable prior art methods, are well known in the art.

Statutes and laws in effect in certain jurisdictions have empowered electronic signatures, when effected to satisfy all legal requirements of the relevant jurisdiction, as effective and legally recognized memorializations and/or documentation of various types of contractual performance, offers, acceptances, endorsements, witnessing confirmations, oaths, declarations, notifications and/or certifications. Certain statutes have authorized electronic signatures as valid to rely upon for confirming the age and identity of the signer. These electronic signature statues have increased the capability of communications devices and networks as media for implementing and recording legally recognizable acts, such as acts or conditions relating to tax liability, contractual formation, performance and fulfillment, and the of purchase, sale, issuance or transference of authority, license, interest, equity and/or ownership rights.

The need has arisen for a method to associate the location of a communications device during a communications session in order to comply with specific legal requirements attendant to executing a preferred, or a legally recognizable, or an authorized, transmission of a request, an enquiry, a document or a testimony, and in combination with an authentication of the identity of one or more specific persons associated with, or originating, the authorship of the document, transmission or request.

### SUMMARY OF THE INVENTION

It is therefore an object of the present invention to provide a method to substantially determine the location of a communications device substantially simultaneous with the transmission of an information between the communications device and another communications device.

It is an optional object of the present invention to provide a system to substantially determine the location of a communications device substantially simultaneous with the transmission of an information between the communications device and another communications device.

It is another optional object of the present invention to determine the location of a GPS enabled communications device substantially simultaneous with the transmission of an information between the communications device and a second party, such as another communications device.

It is still another optional object of the present invention to provide a method of enabling the purchase of lottery tickets by means of a communications device and under the laws of a jurisdiction and within a geography authorized by the laws or governing authority of the jurisdiction.

It is yet another optional object of the method of the present invention to enable the operation of a virtual retail store, wherein the virtual retail store may have some or all of the rights, or privileges of a fixed site physical store, and whereby the virtual retail store may collect transaction fees, sales commissions, and/or performance compensation that might be earned by a fixed site physical store.

It is still another optional object of the present invention to provide a method to enable the operation of a virtual store, the virtual store having all or at least one of the rights or privileges of a traditional, physical store, such as the right to sell lottery tickets or to collect sales commissions on lottery ticket sales.

It is a further optional object of the present invention to provide a method to enable the operation of a virtual store, the virtual store authorized to sell lottery tickets or accept wagers as authorized by a state governmental gaming or lottery commission, or as authorized by a legally empowered licensee or sub-licensee of a state governmental gaming or lottery commission.

It is a still further optional object of the present invention to provide a method to authenticate the identity of a requesting person located remotely from a recipient of a communication issued by the requesting person.

It is another optional object of the present invention to provide a method to pay-out a monetary value or other reward to a device or person located remotely from a recipient of a communication issued by a device or person requesting or receiving the pay-out.

Towards these objects, and other objects that will be made obvious in light of the present disclosure, a method and system to enable remote electronic messaging communications between a person and device, and a virtual store or a remote vendor is provided.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic diagram of a communications network within which a preferred embodiment of the method the present invention may be implemented.

FIG. 2 is a schematic diagram of a preferred embodiment of the communications device of FIG. 1.

FIG. 3 is a schematic diagram of a preferred embodiment of the wireless communications device of FIG. 1.

FIG. 4 is a process flow chart of a first preferred embodiment of the present invention.

FIG. 5 is a process flow chart of a second preferred embodiment of the present invention.

### DETAILED DESCRIPTION OF A PREFERRED EMBODIMENT

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

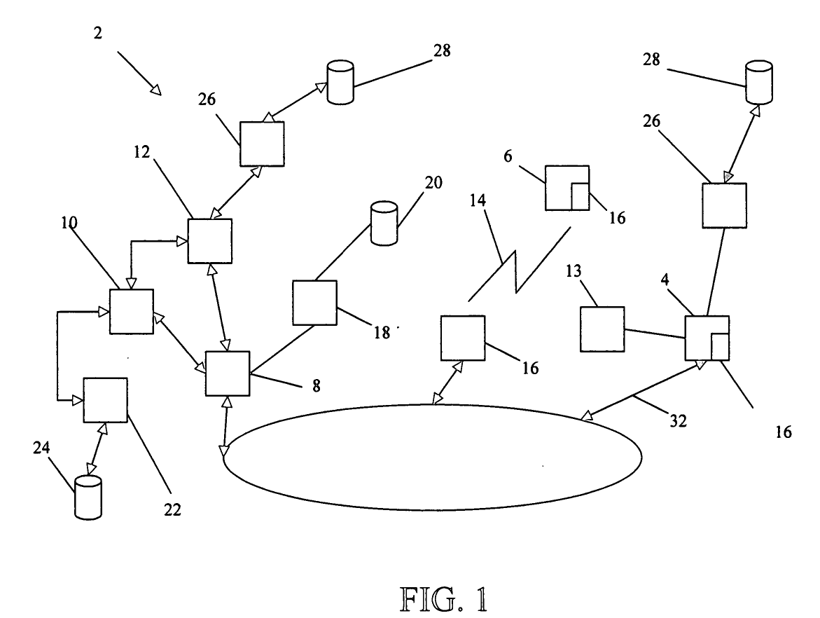

Referring generally to the Figures and particularly to FIG. 1, FIG. 1 is a schematic diagram of a communications network 2 within which a preferred embodiment of the method the present invention may be implemented. The communications network 2, or network 2, links or enables electronic communications among certain equipment, to include a communications device 4, a wireless communications device 6, a virtual retail store 8, an issuing authority 10, a licensed sales agent 12 and an identity authentication module 13. The communications network 2 may comprise a computer network, a telephone network, an Intranet, an extranet, and/or the Internet, in combination or in singularity. The communications device 4, or comms device 4, is linked to the network 2 by electrical signal carrying cable, electrical signal carrying cable wire, or other suitable hard wired known in the art. In certain alternate preferred embodiments of the method of the present invention, the comms device 4 may be or comprise a computer, a personal computer, a video set-top box, a computer game system, a telephone, a electronic mail station, a credit card authorization system, a personal digital assistant, a teletype device, an automated bank teller machine, a lottery ticket sales system, or other suitable communications device known in the art. In certain alternate preferred embodiments of the present invention, the comms device 4 may be provided to a user by a commercial entity, such as a casino, or a corporation, or government agency, to encourage customer loyalty to the providing entity. A human participant may use the comms device 4 or the wireless communications device 6, or wireless device 6, to transmit an information to the virtual retail store 8 via the network 2. The participant may be physically located within a facility related to the virtual store 8 of a casino, such as a person placing a wager with a casino via a cell phone 4 while sitting in a restaurant of the casino. The term credit card is defined herein to comprise a variety of suitable cards and media known in the art that are used as electronic purses, stored value cards, e-money accounts, e-money account cards or records, smart cards, credit cards, debit cards, automated teller machine cards, financial account access instruments, and funds transfer authorization instruments. Smart cards, such as electronic purses, stored value cards, e-money accounts, e-money account cards or records, may be configured with two or more accounts, where each account is related to a specific purchasing service or gambling operation, e.g., a particular electronic purse or a specific stored value card may have an account record for a credit account and a user account with a casino, and a separate credit and user account with a specific state lottery or lottery licensee. The account may alternatively be predefined by the issuing authority 10, the licensed sales agent 12, the virtual store 8, and/or another commercial, corporate or governmental agency.

The wireless device 6 communicates with the network 2 via a wireless communications link 14 to a wireless communications station 15 of the network 2. The wireless communications station 15 may be or comprise a cellular phone communications equipment or other suitable wireless communications enabling equipment known in the art. In certain alternate preferred embodiments of the method of the present invention, the wireless device 6 may be or comprise a wireless communications enabled computer, personal computer, video set-top box, computer game system, telephone, electronic mail station, credit card authorization system, personal digital assistant, teletype device, automated bank teller machine, a lottery ticket sales system, or other suitable wireless communications device known in the art. The user may, in certain preferred embodiments of the method of the present invention, employ the comms device 4 to initiate or support a communications transaction with the virtual store 8, or remote vendor 8, and related to a sale, a purchase, or a lease. The user may, in certain alternate preferred embodiments of the method of the present invention, employ the comms device 4 to initiate or support a pay-out communications transaction with the remote vendor 8. The pay-out communications may be, or comprise, or be related to, a pay-out to the user of a reward, a coupon, a gambling winning, a wager, a lottery jackpot, a credit, or another transfer of value, title, property, option, right, privilege or service. The user may, in certain still alternate preferred embodiments of the method of the present invention, employ the comms device 4 to initiate or support a communications transaction with the remote vendor 8 and related to the documentation, certification, accounting, or collection of attendance data and/or time references.

In certain yet alternate preferred embodiments of the method of the present invention, historical or user profile information may be stored and maintained, wherein said information is related to a transaction and/or an individual, and the information may enable or support correct processing of information. Said information may include:

billing and billing authorization information;

gambling/lottery transaction data;

Time tracking data related to a billed activity, e.g., user profile, company name, bill rate, description of activity and measures of time expended; and

Legal instrument service data, such as delivering or serving a subpoena or court order by a process server, wherein the data may inlude billing rate information, a case number, a docket number, and/or data substantiating actual delivery.

In certain preferred embodiments of the method of the present invention, the participant may transmit a request to purchase a lottery ticket in a communications session initiated from and enabled by the wireless device 6. The purchase request may pass via the wireless communications station 14 through the network 2 and to the virtual retail store 8, or second party 8. The virtual retail store 8 may then issue a derivative purchase request to the issuing authority 10. The virtual retail store 8 may be a remote vendor 8 wherein the remote vendor 8 interacts with a purchaser by means of the network 2 to participate in a communications transaction, such as a communication of a purchase request by the purchaser. The issuing authority 10 may accept or deny the participant's purchase request, and issue a receipt of the instant acceptance or denial back to the remote vendor 8. The remote vendor 8 may then generate a secondary receipt of the acceptance or denial of the participant's lottery ticket purchase request and communicate the secondary receipt via the network 2 to the wireless device 6. Alternatively, the participant may use the comms device 4 to transmit the lottery ticket purchase request via the network 2 to the remote vendor 8, and to receive the secondary receipt from the remote vendor 8. Still alternately, the remote vendor 8 may initiate a communications session when a predetermined condition is achieved, such as when a lottery jackpot has reached a pre-selected magnitude. The remote vendor 8 may thereby solicit purchase requests from the user. The receipt may include time date stamps, or other information associated with a transaction related to the purchase request. The receipt may optionally, alternatively or additionally transmitted to the comms device 4 as a verbal message.

In certain preferred embodiments of the method of the present invention a record or notice of the transaction request, or of a following or associated completed transaction, may be communicated to a tax authority of a government, and the issuing authority may be, comprise, or act in concert with a tax agency of a government. As one example of a tax related transaction, a sales tax liability may be calculated and assigned on the basis of the location of the remote purchaser using the comms device 4 and/or the location of the remote vendor at the moment that a sale is transacted. As another example of a tax related transaction, user tax liability may be calculated and assigned on the basis of the location of the remote purchaser using the comms device 4 and/or the location of the remote vendor at the moment that a communication is effected.

In certain preferred embodiments of the present invention the issuing authority 10 or the remote vendor 8 may originate or transmit a notification alert to the user. The notification alert optionally contains information related to the transaction request, such as a winning result of a wager, or to a suggested, potential or solicited transaction request.

In certain alternate preferred embodiments of the method of the present invention, the wireless device 6 may comprise or be coupled with a GPS receiving circuit 16. The GPS circuit 16 may be located in, or coupled with, an automobile, or other equipment, or a smart card or other separate media. The GPS circuit 16, or GPS 16, receives GPS signals from the global positioning system and provides these signals, or data generated by processing these GPS signals, as a location information to the wireless device 6 or optionally to the network 2. In certain preferred embodiments of the method of the present invention wherein the wireless device 6 is or comprises a cell phone or a personal digital assistant, or other suitable wireless enabled communications device, the location information may be transmitted to the network 2 within a channel or subchannel of a communications session, such as a phone call or a wireless communications transmission. The location information may pass via the wireless communications station 14 through the network 2 and to the remote vendor 8. The remote vendor 8 may retransmit the location to the issuing authority 10, or the remote vendor 8 may determine that the location information indicates that the wireless device 6 is located within a geographic region wherefrom the purchase of a lottery ticket is authorized by the issuing authority 10 and/or a relevant governmental body or agency having legal jurisdiction applicable within the geographic region. The issuing authority 10 may optionally and/or independently accept the location information, independently verify that the location information indicates that the wireless device 6 is located within a geographic region wherefrom the purchase of a lottery ticket is legally permitted, and accept or deny the participant's purchase request. The issuing authority 10 may then issue a receipt of the instant acceptance of a purchase request or a denial of the purchase request back to the remote vendor 8. The remote vendor 8 may then generate a secondary receipt of the acceptance or denial of the participant's lottery ticket purchase request and communicate the secondary receipt via the network 2 to the wireless device 6. Alternatively, where the comms device 4 comprises or is coupled with a GPS 16, the participant may use the comms device 4 to transmit both the lottery ticket purchase request and the location information of the comms device 4 via the network 2 to the remote vendor 8, and to receive the secondary receipt from the remote vendor 8.

Authentication of the GPS data as transmitted from the comms device 4 may optionally be performed at by the issuing authority 10, the remote vendor 8, or another equipment.

In certain still alternate preferred embodiments of the method of the present invention, the lottery ticket purchaser may initiate or participate in a direct communications link with the issuing authority 10 via the network 2 and the remote vendor 8, and the inclusion of the remote vendor 8 in the transaction may be noted or credited in the receipt as issued by the issuing authority 10 or other source.

In certain yet alternate preferred embodiments of the method of the present invention a receipt or a notification of a condition, such as the selection of the user's lottery ticket as a winning ticket, may be transmitted to the user by a fax transmission, an email, or a phone call.

The remote vendor 8 has an optional computer system 18 coupled with or including a data storage module 20. User records may be maintained in the data storage module 20 that comprise a database. Each or some of the user records may optionally include, in combination or singularity, for each or certain potential or actual participants in, or users of, the computer network 2, data associated with a specified participant or user, to include identification information, account numbers, passwords, credit accounts, debit accounts, financial data, biometric identification data, stored sets of favored lottery number combinations, a usage or purchasing history, shipping information, billing information, purchasing preferences and other participant or user specific information. The usage history may contain information useful in maintaining or building an audit trail of the user's identity and activities and the actions of other parties. It is understood that a password, as used and defined in this disclosure, may be or comprise a personal identification number (“PIN”).

The terms user and participant are used as synonyms in this disclosure and are defined herein to have to designate a person communicating, or intending to communicate, with the remote vendor 8.

The issuing authority 10 may have an optional authority computer system 22 coupled with or including an authority data storage module 24. The user records discussed in the preceding paragraph may be stored as back-up data storage and be comprised in a database within the authority data storage module 24. Alternatively or additionally the user related data stored in the authority data storage module 24 may be a subset, a superset, or a complimentary set of data as compared or related to the user related data stored in the data storage module 20 of the wireless device 6. In certain alternate preferred embodiments of the present invention the comms device 4 and/or the licensed sales agent 12 may alternatively or additionally have the capability to store data records in an alternate computer system 26 and/or an alternate data storage module 28, and the data records may contain the user related, wherein the stored data may be a subset, a superset, or a complimentary set of data as compared or related to the user related data stored in the data storage module 20 or the authority data storage module 24.

In certain alternate preferred embodiments of the method of the present invention, the present invention provides a location verification and an identity confirmation engine. Towards this object, a biometric input module 26 or the identity authentication module 13 may be coupled with the network 2 and/or the wireless device 6. The identity authorization module 13 may accept input identity information from a user's document such as a drivers license, a government issued identification card, an RFID medium, or another personal identification medium. The identity identification may then be communicated from the identity authentication module 13 to the remote vendor 8 via the network 2, and compared against matching identity identification associated with the participant and stored in the data storage module 20, the authority data storage module 24, or an alternate data storage module coupled with the network 2, the licensed sales agent 12, and/or the comms device 4.

The biometric input module 26 may optionally, alternatively or additionally receive a biometric measurement from the participant, such as a fingerprint, a thumbprint, a handprint, a facial view, an iris pattern, an eye retina image, a voice print, or another suitable biometric parameter known in the art. The biometric measurement may then be communicated from the biometric input module 26 to the remote vendor 8 via the network 2, and compared against biometric data associated with the participant and stored in the data storage module 20, the authority data storage module 24, or an alternate data storage module coupled with the network 2, the licensed sales agent 12, and/or the comms device 4. The stored biometric data may be or comprise a fingerprint, a thumbprint, a handprint, a facial photo, an iris pattern, an eye retina, a voice print, or other suitable biometric data known in the art. In certain still alternate preferred embodiments of the method of the present invention the biometric measurement module 26 may be additionally or alternately coupled with the network 2 or the comms device 4.

The licensed sales agent 12 may be a person, a corporations an association, or an entity that has a contractual and/or commercial relationship with the issuing authority 10 to sell goods or services, or to perform actions, as an agent or as sales agent or of the issuing authority 10. The licensed sales agent 12 may be permitted by the issuing authority to execute a sublicense agreement with the remote vendor 8 in which the remote vendor 8 performs actions in performance of a license or permission issued by the issuing authority 10 and to the licensed sales agent 12. The remote vendor 8 may thereby be authorized to act as a point of sale for the licensed sales agent 12, or to perform some other acts or transactions on behalf of the sales agent 12, whereby the remote vendor 8 may earn a sales commission or a performance fee for sales or other actions made on behalf of the licensing sales agent 12 and/or the issuing authority 10. As an illustrative example, consider a scenario where the issuing authority 10 is empowered by the State of California to license the 7-11 CORPORATION, or another convenience store chain, to sell lottery tickets within California, and the issuing authority 10 allows the 7-11 CORPORATION's licensed sales agent 12 to sublicense lottery ticket sales to the remote vendor 8. Alternatively, the 7-11 CORPORATION may not be explicitly authorized to sublicense, but does in fact contract with the remote vendor 8 for the remote vendor 8 to sell lottery tickets under proper or improper exploitation of the permission of the issuing authority 10.

Certain alternate preferred embodiments of the method of the present invention comprise operational practices that comply with the laws and regulations of the jurisdiction within which the issuing authority 10 has legal authority to transact sales of lottery tickets, to sell other goods or services known in the art, or to perform other suitable activities known in the art.

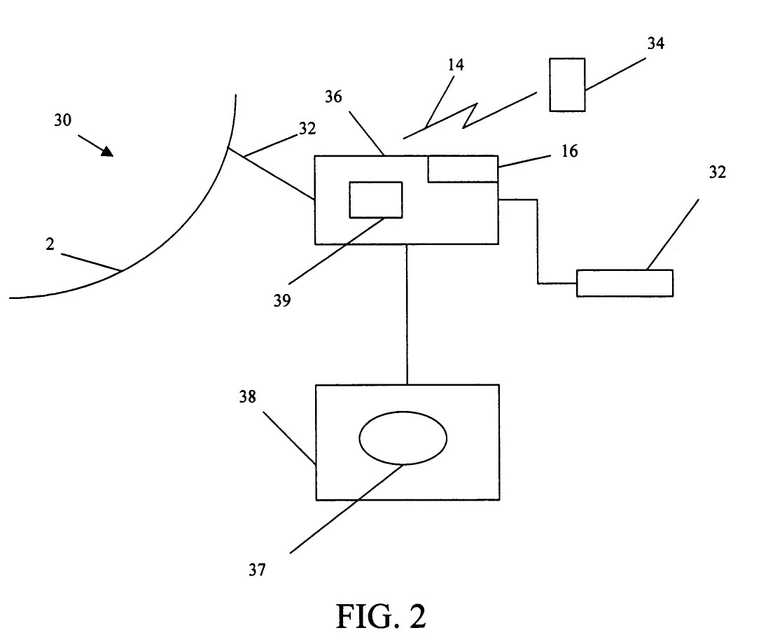

Referring generally to the Figures and particularly to FIG. 2, FIG. 2 is a schematic diagram of a preferred embodiment 30 of the comms device 4, or set-top box system 30. The set-top box system 30 is in communication with the network 2 by means of a video signal cable 32. The user of the set-top box system 30 uses to enter and transmit messages via the network 2 and to the remote vendor 8. The user may user a keypad 32, or keyboard 32, or a handheld remote control 34 to enter data into a set-top box 36, and to initiate the transmission of the entered data to the network 2. Messages transmitted via the network 2 may be displayed to the user on a video screen 37 of a television 38. The GPS circuit 16 receives signals from the global positioning system and provides all or part of the information contained in the signals to a controller 39 of the set-top box 36. The set-top box 36 includes all or part of the information provided by the GPS circuit 16 in a communication session with the remote vendor 8.

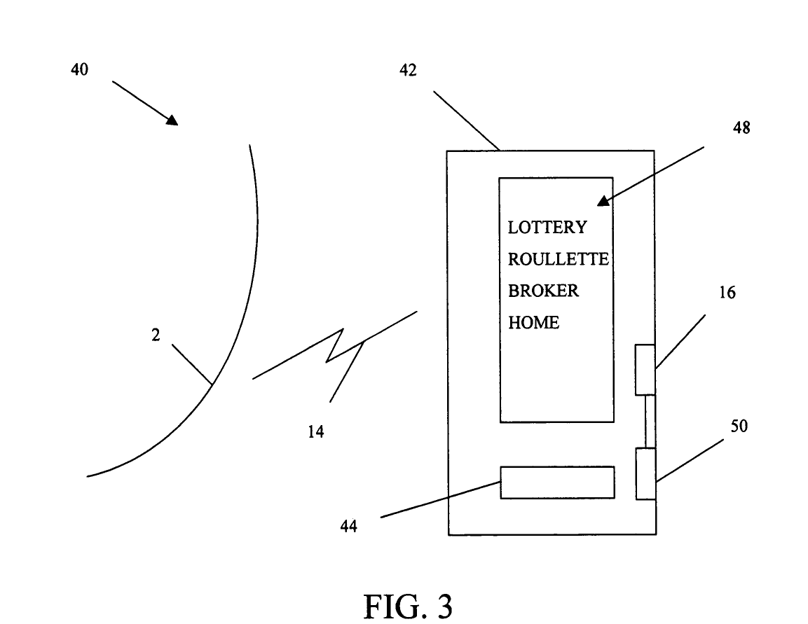

Referring generally to the Figures and particularly to FIG. 3, FIG. 3 is a schematic diagram of a preferred embodiment 40 of the wireless communications device of FIG. 1. The preferred embodiment 40, or wireless PDA 40, is or comprises a wireless personal digital electronic assistant (“PDA”) communications device 42, such as a PALM i705 wireless PDA, or another suitable wireless PDA known in the art. The user may use a data and command entry pad 44, or optionally or alternatively by issuing voice commands, to direct a PDA display screen 46 of the wireless PDA 40 to present a communications menu 48. The user may thereupon select a listing from the communications menu 48 to direct the wireless PDA 40 to initiate a communications session with the remote vendor 8. The GPS circuit 16 receives signals from the global positioning system and provides all or part of the information contained in the signals to a PDA controller 50 of the wireless PDA 40. PDA controller 50 of the wireless PDA 40 includes all or part of the information provided by the GPS circuit 16 in a communication session with the remote vendor 8.

In certain alternate preferred embodiments of the method of the present invention, the PDA 40 or the comms device 4 may reference the GPS signal data to determine which betting options that are contemporaneously authorized by the presence of a person meeting legal requirements, e.g., competency and majority. The comms device 4 may thereby expedite the user's betting experience by providing a menu of accessible betting options that are authorized prior to an attempt to place a bet or purchase a lottery ticket, rather than allow the user to attempt placing an impermissible wager which is ultimately rejected.

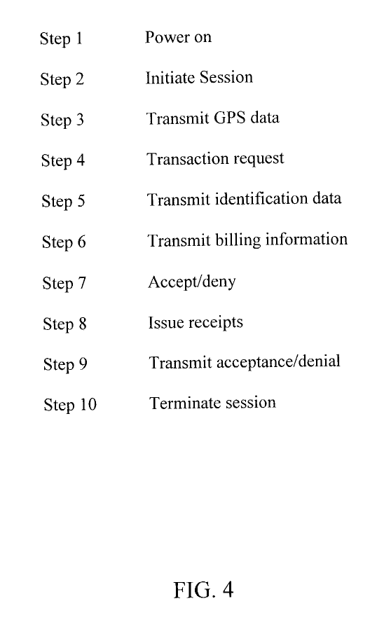

Referring generally to the Figures and particularly to FIG. 4, FIG. 4 is a process flow chart of a first preferred embodiment of the present invention. In step 1, the user's communications device, such as the comms device 4 or the wireless device 6 is turned on. The user then directs the communications device to initiate a communications session with the remote vendor 8 in step 2. The communications device next accepts and includes data from the GPS circuit into a message addressed to the virtual retail store in step 3. In step 4 the user then directs the communications device to request a transaction with the remote vendor 8. As an illustrative set of optional requests, the user may attempt by means of the transaction request of step 4 to (a.) purchase a lottery ticket with having one or more selected numbers as provided by the user within the instant session, (b.) purchase a lottery ticket comprising a set of selected numbers that have been stored by the remote vendor 8, the licensed sales agent 12, or the issuing authority 10, and as referred to, or indicated, within the instant communications session by the user, or (c.) purchase a lottery ticket comprising one number or a set of numbers as randomly or otherwise chosen by the remote vendor 8, the licensed sales agent 12, or the issuing authority 10. The set of numbers may be selected in accordance with a game scenario defined or applied by the issuing authority, such as a KENO game, a POWER BALL game, or another suitable gambling scenario known in the art. The user may then, in step 5, optionally provide additional data to the remote vendor 8, such as identification data related to or associated with the user, to include an account number, biometric data, a password, or other user specific or related data. In optional step 6 the user may provide credit card or other billing information to the remote vendor 8, or may reference billing information as previously stored by and accessible to the remote vendor 8, the licensed sales agent 12, or the issuing authority 10. The user may additionally authorize the billing to a credit account, or other financial account, for payment of the purchase request made in step 6. In step 7 the remote vendor 8 next determines if the transaction request of step 4 may be accepted and performed upon. This determination may be based upon confirming the validity and status of (1) the user identification data of step 5 and the billing data of step 6, and (2) data related to the user identification data and the billing data, e.g., the age of the user or the approval of the transaction by a relevant financial agency. If the request is authorized, the issuing authority 10 may provide a first receipt to the remote vendor 8, and the remote vendor 8 may thereupon generate a second receipt and provide the second receipt to the communications device. Either or both the first and second receipt may optionally include a time and date stamp relating to the timing of the instant communications session. In step 9 the user is informed of the acceptance or denial of the requested transaction, and the communications session is terminated in step 10.

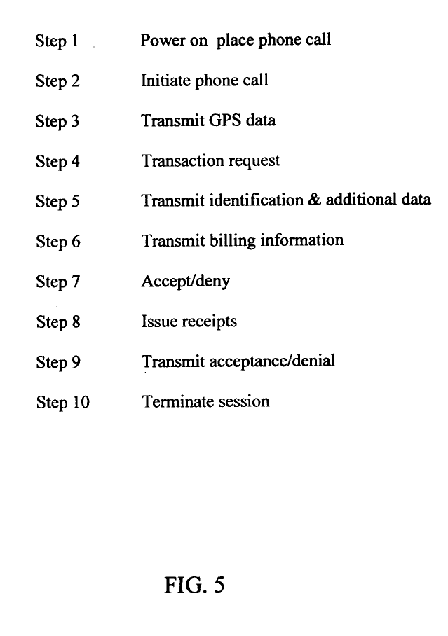

Referring generally to the Figures and particularly to FIG. 5, FIG. 5 is a process flow chart of a second preferred embodiment of the present invention, wherein the user's communications device is a cell phone, and the remote vendor 8 accepts information provided by the user during a phone call and via the network 2. In step one the cell phone places a phone call to the remote vendor 8 via the communications network 2 to the remote vendor 8. The cell phone next receives and includes data from the GPS circuit 16 into a message addressed to the remote vendor 8 in step 3. In step 4 the user then requests a transaction via the cell phone with the remote vendor 8. As an illustrative set of possible transaction requests, the user may attempt by means of the transaction request of step 4 to (a.) record an electronic signature related to a legal document, (b.) record verbal testimony, (c.) authorize the transfer of title of personalty, (d.) authorize the sale or purchase of a registered security or registered security sales option, and/or (e.) authorize a transfer of funds. The user may then, in step 5, optionally provide additional data to the remote vendor 8, such as identification data related to or associated with the user, to include an account number, biometric data, a password, or other user specific or related data. In optional step 6 the user may provide credit card or other billing information to the remote vendor 8, or may reference billing information as previously stored by and accessible to the virtual store 8, the licensed sales agent 12, or the issuing authority 10. The user may additionally authorize the billing to a credit account, or other financial account, for payment of the purchase request made in step 6. In step 7 the remote vendor 8 next determines if the transaction request of step 4 may be accepted and performed upon. This determination may be based upon confirming the validity and status of (1) the user identification data of step 5 and the billing data of step 6, and (2) data related to the user identification data and the billing data, e.g., the age of the user or the approval of the transaction by a relevant financial agency. If the request is authorized, the issuing authority 10 may provide a first receipt to the remote vendor 8, and the remote vendor 8 may thereupon generate a second receipt and provide the second receipt to the communications device. In step 9 the user is informed of the acceptance or denial of the requested transaction, and the communications session is terminated in step 10. The user may, in certain alternate preferred embodiments of the method of the present invention, generate an electronic message to the remote vendor 8 via a voice command sent by the cell phone 4 or other device to the remote vendor 8. The user may optionally, additionally or alternatively create and transmit data to the remote vendor via a keyboard coupled with the cell phone 4.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A method for transmitting a transaction communication within a predesignated geography, by means of a communications device, the communications device coupled with a GPS circuit, the method comprising:
a. initiating a communications session between the communications device and a second party;
b. receiving a GPS reading, the GPS reading determined from the GPS circuit and proximate to the time of initiation of the communications session;
c. transmitting a transaction request communication from the communications device to the second party and within the communications session;
d. transmitting the GPS reading to the second party, and determining if the GPS reading indicates a location sufficiently within the predesignated geography; and
e. issuing an approval by the second party of the transaction request when the GPS reading is determined to be sufficiently within the predesignated geography.

2. The method of claim 1, wherein the method further comprises providing billing and billing authorization information within the communications session to the second party.

3. The method of claim 1, wherein the method further comprises:
f. establishing an account and an associated account number for a registered user and providing access to the account and associated account number to the second party; and
g. providing the account number within the communications session to the second party.

4. The method of claim 1, wherein the method further comprises:
f. providing a password to the second party within the communications session;
g. confirming the validity of the password by the second party; and
denying the transaction request communication when the provided password does not properly relate to a previously stored password.

5. The method of claim 4, wherein the method further comprises:
h. establishing an account for a registered user; and
i. providing the account number within the communications session.

6. The method of claim 1, wherein the transaction request communication comprises a request to purchase a lottery ticket.

7. The method of claim 1, wherein the transaction request communication comprises the placement of a wager within a gambling scenario.

8. The method of claim 1, wherein the transaction request communication is comprised within a transfer of title of a registered security.

9. The method of claim 1, wherein the communications device is a cellular telephone, the communications session comprises a phone call, and the GPS reading is provided within the communications session to the second party.

10. The method of claim 1, wherein the method further comprises an issuing of a receipt by the second party, the receipt documenting the transaction request communication.

11. The method of claim 10, wherein the method further comprises providing a receipt number associated with the receipt to a user of the communications device and within the communications session.

12. The method of claim 10, wherein the method further comprises providing a receipt number associated with the receipt to an email address.

13. The method of claim 10, wherein the method further comprises providing a receipt number associated with the receipt via a fax system.

14. The method of claim 7, wherein the method further comprises notifying a user of a resulting win from the wager in a communication selected from the group consisting of a second communications session, an email and a fax transmission.

15. The method of claim 1, wherein the method further comprises transmitting alphanumeric input within the communications session and by means of a keypad of the communications device.

16. The method of claim 6, wherein the method further comprises selecting lottery number choices by transmitting alphanumeric input within the communications session and by means of a keypad of the communications device.

17. The method of claim 6, wherein the transaction communication further comprises transmitting an instruction from the communications device directing the second party to make a lottery number choice.

18. The method of claim 17, wherein the method further comprises time and date stamping of a record of the transaction request communication.

19. The method of claim 6, wherein the method further comprises:
f. storing a set of lottery number choices;
g. associating the set of lottery number choices with a user; and
h. purchasing a lottery ticket comprising the set of lottery number choices when directed by the user and within the communications session.

20. The method of claim 6, wherein the method further initiating an alerting communications session with the communications device when a jackpot of a predesignated lottery drawing exceeds a preset limit and informing a user thereof.

21. The method of claim 1, wherein the communications device further comprises a text signal generating module, and providing a text message generated by means of the text signal generating module within the communications session.

22. The method of claim 6, wherein the method further comprises enabling the second party to accept verbal communication from the communications device, and enabling the communications device to transmit verbal data to the second party, whereby information may be provided to the second party by the means of the user speaking into the communications device.

23. The method of claim 1, wherein the method further comprises:
j. providing a biometric data to the second party within the communications session;
k. confirming the validity of the biometric data by the second party; and
l. denying the transaction request communication when the biometric data does not substantially match a previously stored biometric data.

24. The method of claim 1, wherein the communications device further comprises a visual menu display, and the method further comprises providing information to the second party by making selections from the visual menu display.

25. The method of claim 1, the method further comprising:
f. transmitting personal identification data from the communications device to the second party;
g. comparing the transmitted personal identification data with recorded personal identification data stored in a database; and
h. denying authorization of the transaction when the transmitted personal identification data does not match the recorded personal identification data.

26. The method of claim 1, wherein the method further comprises time and date stamping of a record of the transaction request communication.

27. The method of claim 10, wherein the receipt comprises details of a transaction related to the transaction request.

28. The method of claim 1, wherein the method further comprises transmitting input to the second party within the communications session and by means of a voice input from the communications device.

29. The method of claim 1, wherein the method further comprises an issuing of a verbal receipt by the second party, the verbal receipt documenting the transaction request communication.

30. The method of claim 1, wherein the method further comprises an issuing of a notification alert by the second party, the notification alert comprising information related to the transaction request.

31. The method of claim 1, wherein the method further comprises reporting the transaction request communication to a tax authority.

32. The method of claim 1, wherein the communications session further comprises a pay-out communication to the communications device.

33. The method of claim 1, wherein the communications session further comprises a communication of a attendance data.

34. The method of claim 1, wherein the communications session further comprises a communication of an information documenting a delivery of a legal instrument.

35. The method of claim 1, wherein the communications session further comprises a communication of an information documenting a time tracking related to billed activity.
